(19) United States
(12) Patent Application Publication
(10) Pub. No.: US 2006/0138218 A1
(43) Pub. Date: Jun. 29, 2006

(54) Product matching shopping contest

(76) Inventor: Dino Scorziello, Akron, OH (US)

Correspondence Address: DINO SCORZIELLO, 2037 WILMICH DR, AKRON, OH, 44319, US

(21) Appl. No.: 11/022,591

(22) Filed: Dec. 28, 2004

(51) Int. Cl. G06K 15/00; G06Q 20/00

(52) U.S. Cl. 235/383; 705/16

(57) ABSTRACT

A retail contest consisting of a product database (30) containing the items for sale in a store, a designated winning-list of items (40) containing items selected from the product database (30) and an electronic cash register or computer with product identification means (20) that can identify the items (10) a contestant (1) is purchasing (15). The electronic cash register or computer with product identification means (20) can also compare (25) the items being purchased (10) against the items listed in the designated winning-list of items (40). The result of the comparison (25) is then displayed (50) to the contestant (1) on a screen or receipt.

### CROSS-REFERENCE TO RELATED APPLICATIONS

Not applicable.

### BACKGROUND

1. Field of Invention

This invention relates to contests conducted by retailers, specifically to such contests which requires shoppers to purchase specific items in order to win.

2. Description of Prior Art

Retailers normally have contests that require contestants to fill out a ballot and wait for a random drawing, on a designated date, in order to select a winner. However, most shoppers are in too much of a rush to fill out a ballot, and they are wary of writing their contact information on a ballot that will given to third parties, such as telemarketers, later on. To avoid these inconveniences most eligible contestants decide not to enter most retail contests. Consequently, retailers wanting to promote their stores or products find it difficult to get disenfranchised consumers to enter their contests.

Other retail contests require customers to purchase only certain, more expensive items in order to have a chance at winning the contest. For example, fast food restaurants conducting contests usually require customers to purchase the larger, more expensive menu items, in order to receive a game piece and thus obtain a possibility of winning a prize. This prevents other customers who can't afford the more expensive items or who didn't want to order those food categories, from participating in the contest. Contests such as these alienate customers who do not order the designated menu items, causing resentment and the future loss of sales.

### SUMMARY

In accordance with the present invention, a retail contest consists of products for sale in a store or restaurant, a database of the items for sale in the store or restaurant, a winning-list of items pre-selected from the store's product database, and an electronic cash register or computer that can identify the items being purchased and which is connected to or contains the store's product database and winning-list of items, in its memory.

When a purchase is made, the electronic cash register or computer identifies each item and compares the items purchased to those contained in the winning-list of products. If the items purchased match the items on the winning-list, then the customer wins a reward. If the items purchased do not match the items on the winning-list, then the customer does not receive a reward. In either case the result is displayed to the customer.

### OBJECTS AND ADVANTAGES

Accordingly, several objects and advantages of my invention are:
a) to provide retailers a contest that will ensure a large entrant to customer ratio.
b) to provide customers with an easy, convenient way to be entered in a contest given by a retailer.
c) to provide customers a way to participate in a contest without limiting their eligibility to the purchase of special or expensive items.
d) to provide customers a way to participate in a contest and know, at the time of purchase whether they will receive a reward or not.
e) to provide retailers with a contest that will not disenfranchise customers by causing them inconveniences in order to enter the contest or by having their contact information given to third parties.
   Further objects and advantages are to provide a contest, which can be easily and conveniently, conducted using databases and checkout equipment already in use by the retailer. Still further objects and advantages will become apparent from a consideration of the ensuing description and drawing.

### DRAWING FIGURES

FIG. 1 shows a flowchart describing how a customer enters a retail contest and how to determine if he/she is given a reward or not, based on the items he/she purchases.

### REFERENCE NUMERALS IN DRAWINGS

1—contestant
5—shopping
10—items to be purchased
15—purchase/check out
20—electronic cash register or computer with product identification means
25—compare
30—product database
40—designated winning-list of products
45—determination
50—display result

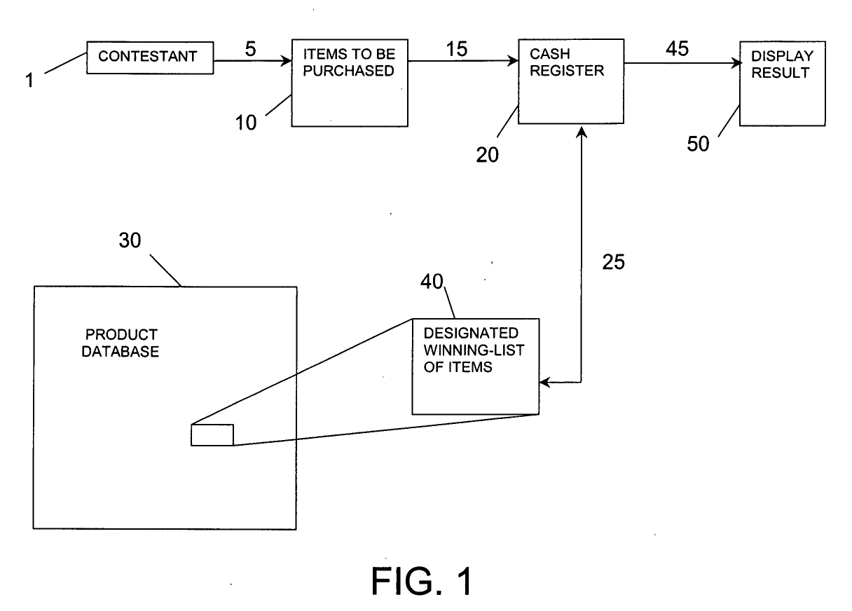

### DESCRIPTION—FIG. 1—PREFERRED EMBODIMENT

FIG. 1 shows how a contestant 1 enters a product matching shopping contest and how to determine if he/she is given a reward or not based on the items 10 he/she intends to purchase.

Stores maintain a comprehensive list of all the products they offer for sale to their customers. An electronic version of this list stored in a computer's memory is called the store's product database 30. The product database is usually updated and manipulated using a database software such as Microsoft Access or Excel. From the store's product database 30, a subset of items is selected to form the designated winning-list of items 40. The designated winning-list of items 40 may consist of just one item or of a plurality of items from the store's product database 30.

A contestant 1 is a customer of a business conducting a product matching shopping contest. The contestant 1 will be shopping 5 for items to be purchased 10. The items to be purchased 10 are whatever the contestant 1 desires to buy at that store at that time. The contestant 1 must purchase/checkout 15 the items 10 using an electronic cash register or computer with product identification means 20. The electronic cash register or computer with product identification means 20 must also have the means to compare 25 the items to be purchased 10 against the designated winning-list of items 40. The electronic cash register or computer with product identification means 20 must also have the means to come to a determination 45 as to whether the contestant 1 wins or loses. The electronic cash register or computer with product identification means 20 must also have the means to display the result 50 of the determination 45 when the determination process is complete. The displayed result 50 may be on a screen or a printed receipt or both.

### ADVANTAGES

From the description above, several advantages of my product matching shopping contest become evident:
(a) The product matching shopping contest can be easily conducted by on-line, Internet based retailers.
(b) Companies that sell services can also use this method to conduct a contest. In this case, services will be purchased instead of or in combination with products.
(c) The product matching shopping contest is quick to conduct and utilizes equipment and software already in use by the retailer.

### OPERATION—FIG. 1

The manner of operating the product matching shopping contest invention is illustrated in FIG. 1. A contestant 1 conducts his/her shopping 5 and collects items to be purchased 10. When the contestant 1 has completed shopping he/she will purchase/check out 15 the items by allowing an electronic cash register or computer with product identification means 20 to identify their selected items 10. The electronic cash register or computer with product identification means 20 will compare 25 the items being purchased 10 against those on the designated winning-list of items 40 which is chosen from the larger product database 30. The electronic cash register or computer with product identification means 20 will also determine 45 if all the items on the designated winning-list of items 40 were purchased. If all the items on the designated winning-list of items 40 were purchased by the contestant 1 then the electronic cash register or computer with product identification means 20 will display a win result 50 on its screen and/or the contestant 's 1 receipt. If all the items on the designated winning-list of items 40 were not purchased by the contestant 1 then the electronic cash register or computer with product identification means 20 will display a lose result 50 on its screen and/or the contestant 's 1 receipt.

### CONCLUSION, RAMIFICATIONS AND SCOPE

Accordingly, the reader will see that the product matching shopping contest invention can be conducted by a retailer easily and conveniently. Contestants can participate in such a contest without being inconvenienced to fill out an entry ballot and they can know whether they will receive a reward or not when they complete their purchase. The contest does not disenfranchise customers by collecting their contact information and then distribute it to tele-marketers or other third parties. It also allows for more customer participation by not restricting what they can buy in order to participate in the contest.

This invention also has the advantage of being able to be used by on-line, Internet based retailers. Also, this invention can have a product database that includes services or a combination of products and services. For example an automotive service company's database may contain products such as shock absorbers and services such as oil changes. Their designated winning-list of items can consist of a combination of products and services.

I claim:

1. A method of selecting a winner of a contest, comprising of:
(a) providing a means of designating a winning-list of items, pre-selected from a larger list of items,
(b) providing a means of comparing a contestant's selected items to those in said designated winning-list of items,
(c) providing a means of displaying the results of said comparison to the contestant,
whereby a contestant will be deemed a winner if the items he/she selected match the items on said designated winning-list of items.
